(19) United States
(12) Patent Application Publication
(10) Pub. No.: US 2023/0112842 A1
(43) Pub. Date: Apr. 13, 2023

(54) Method and System for Synergy with Transportation Route and Selective Harvesting Supply Chain Logistics

(71) Applicant: INTERNATIONAL BUSINESS MACHINES CORPORATION, ARMONK, NY (US)

(72) Inventors: Randy A. Rendahl, Raleigh, NC (US); Martin G. Keen, Cary, NC (US); Jeremy R. Fox, Georgetown, TX (US); Sarbajit K. Rakshit, Kolkata (IN)

(21) Appl. No.: 17/499,115

(22) Filed: Oct. 12, 2021

(51) Int. Cl. G06Q 10/06; G06Q 50/02; G06Q 10/08; G06Q 50/30

(52) U.S. Cl. CPC G06Q 10/063114; G06Q 10/08; G06Q 10/0633; G06Q 50/02; G06Q 50/30

(57) ABSTRACT

A harvesting supply chain logistics system for coordinating the harvest and transport of crops from multiple food producers. The system receives first crop data of a first crop grown at a first location by a first food producer. The system predicts a first harvesting time and a first harvesting amount of the first crop. The system receives second crop data of a second crop grown at a second location by a second food producer. The system predicts a second harvesting time and a second harvesting amount of the second crop. The system determines whether a transport for the first crop and the second crop can be combined based on the first harvesting time, first harvesting amount, the second harvesting time, and the second harvesting amount. The system schedules a combine transport of the first crop and the second crop when the first crop and the second crop can be combined.

### BACKGROUND

According to United States Department of Agriculture (USDA), between 30% and 40% of the entire food supply in the United States is wasted every year. About half of this loss is due to supply chain inefficiencies at the producer or grower level.

### SUMMARY

The present disclosure provides various systems and method for improving the synergy between transportation and selective harvesting supply chain logistics. As a non-limiting example, in an embodiment, a harvesting supply chain logistics system for coordinating the harvest and transport of crops from multiple food producers is disclosed. The system receives first crop data of a first crop grown at a first location by a first food producer. The system predicts a first harvesting time and a first harvesting amount of the first crop. The system receives second crop data of a second crop grown at a second location by a second food producer. The system predicts a second harvesting time and a second harvesting amount of the second crop. The system determines whether a transport for the first crop and the second crop can be combined based on the first harvesting time, first harvesting amount, the second harvesting time, and the second harvesting amount. The system schedules a combine transport of the first crop and the second crop when the first crop and the second crop can be combined.

Other embodiments including a system and computer program product are further described in the detailed description.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a diagram illustrating a network in accordance with an embodiment of the present disclosure.

FIG. 2 is a diagram illustrating a crop harvest knowledge corpus in accordance with an embodiment of the present disclosure.

FIG. 3 is a diagram illustrating a crop harvest prediction and transport process in accordance with an embodiment of the present disclosure

FIG. 4 is diagram illustrating a map in accordance with an embodiment of the present disclosure.

FIG. 5 is a flowchart illustrating a process for predicting a crop harvesting date and transport scheduling in accordance with an embodiment of the present disclosure.

FIG. 6 is a flowchart illustrating a process for optimizing transport of a crop in accordance with an embodiment of the present disclosure.

FIG. 7 is a block diagram illustrating a hardware architecture of a system according to an embodiment of the present disclosure in which aspects of the illustrative embodiments may be implemented.

The illustrated figures are only exemplary and are not intended to assert or imply any limitation with regard to the environment, architecture, design, or process in which different embodiments may be implemented.

### DETAILED DESCRIPTION

It should be understood at the outset that, although an illustrative implementation of one or more embodiments are provided below, the disclosed systems, computer program product, and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

As used within the written disclosure and in the claims, the terms “including” and “comprising” are used in an open-ended fashion, and thus should be interpreted to mean “including, but not limited to.” Unless otherwise indicated, as used throughout this document, “or” does not require mutual exclusivity, and the singular forms “a”, “an” and “the” are intended to include the plural forms as well, unless the context clearly indicates otherwise.

A module or unit as referenced herein may comprise one or more hardware or electrical components such as electrical circuitry, processors, and memory that may be specially configured to perform a particular function. The memory may be volatile memory or non-volatile memory that stores data such as, but not limited to, computer executable instructions, machine code, and other various forms of data. The module or unit may be configured to use the data to execute one or more instructions to perform one or more tasks. In certain instances, a module may also refer to a particular set of functions or computer executable instructions configured to perform a specific task. For example, a module may comprise of software components such as, but not limited to, data access objects, service components, user interface components, application programming interface (API) components; hardware components such as electrical circuitry, processors, and memory; and/or a combination thereof. As referenced herein, computer executable instructions may be in any form including, but not limited to, machine code, assembly code, and high-level programming code written in any programming language.

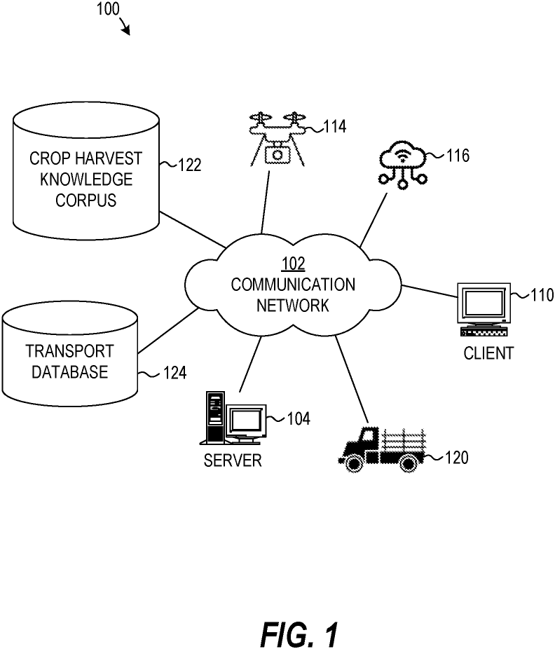

FIG. 1 is a diagram illustrating a network 100 in accordance with an embodiment of the present disclosure. A crop is any type of food product that is grown for consumption such as fruits, vegetables, and grains. The network 100 enables multiple food producers or farmers to share crop data regarding their crops to improve supply chain logistics such as, but not limited to, optimizing transport of the crops.

The network 100 includes a communication network 102 that enables communications between various network devices including, but not limited, a server 104, a client 110, a drone 114, Internet of things (IoT) devices 116, a transport vehicle 120, a crop harvest knowledge corpus 122, and a transport database 124. The communication network 102 can include various types of private networks and/or public networks such as, but not limited to, home networks, local-area networks (LANs), wide-area networks (WANs), and metropolitan-area networks (MANs), cellular networks, service provider networks, and the Internet.

The server 104 represents one or more computing systems (e.g., may be a network of computing systems that operate together, a cloud server, and/or one or more pooled network resources) that provide one or more services, resources, or data to the client 110. A cloud server is powerful physical or virtual infrastructure that performs application/information processing and storage in a cloud computing environment for one or more users. The client 110 represents one or more computing systems that receive services, resources, or data from the server 104. In some embodiments, the client 110 may also send information or data to the server 104 for enabling the server 104 to analyze, process, or perform other services based on the information. For example, in an embodiment, the client 110 may be, but are not limited to, personal computers, mobile devices, or other computing devices of a food producer/farmer, supplier, transporter, warehouse operators, retailers, or other parties along a food supply chain. In an embodiment, the server 104 is a harvesting supply chain logistics system that receives, requests, or otherwise obtains information from the client 110 (e.g., field location information, size of the field, number of trees, type of crops, when planted, crops destroyed, etc.) and stores the information in the crop harvest knowledge corpus 122. The server 104 can aggregate data/information from all along the supply chain (e.g., primary producers, warehouses, manufacturers, distributers, shipping, and retailers) and analyze the data for improving supply chain logistics such as, but not limited to, improving the logistics between transportation and selective harvesting. For example, in an embodiment, the server 104 provides an application that generates a user interface that allows different farmers/food producers to provide images and other information regarding their crops/fields. In an embodiment, the server 104 aggregates and analyzes the information from all the different farmers to predict the harvest date/amount for each grower/field location and optimize transportation between the various growers (e.g., two small farmers in nearby towns may be able to share a transport vehicle).

The server 104 may also obtain information from the drone 114, the IoT devices 116, the transport vehicle 120. In an embodiment, the drone 114 is an autonomous or remote-control flying device that is equipped with one or more image or video capturing device for obtaining images/video of a plurality of farming fields located at different locations including the crops grown at each of the field locations. For example, in an embodiment, the drone 114 may capture images of crops grown at one or more field locations and send the images to the server 104. The server 104 may use the images and compare it to images saved in the crop harvest knowledge corpus 122 to determine the current stage of growth of the crop and predict a harvesting date of the crop using historical data saved in the crop harvest knowledge corpus 122.

In addition to images, the server 104 could receive other information such as, but not limited to, environmental (e.g., current weather information, soil moisture/nutrient content, or crop sampling information) from one or more of the IoT devices 116. The IoT devices 116 are physical objects or machines, that are embedded with sensors, processing ability, software, and other technologies, and that connect and exchange data with other devices and systems over the Internet or other communications networks. For example, the IoT devices 116 can include sensors for measuring the temperature, moisture, soil fertility, or other factors that can affect the growth or yield of a crop. In an embodiment, the IoT devices 116 can include a crop sampling mechanism for sampling a portion or a whole crop at one or more field locations. The sampling may be random (e.g., selecting from different trees and/or selecting some from different locations on a tree (e.g., some from a periphery of tree and some further in the tree)) or may be based on a representative portion of the crops (e.g., avoid selecting crops on the border of the field or crops that may receive more water or sun than other crops in the field). The sampling may be performed weekly, a few times a week, or daily as the crop gets closer to harvesting. The sample can then be used to measure/determine certain characteristics of the crop (e.g., firmness, acidity, size, color, sugar or starch content, etc.) to determine the maturity of the crop. The server 104 can be configured to further use the information obtained from the IoT devices 116 in determining/predicting a harvesting date of the crop based on the historical data saved in the crop harvest knowledge corpus 122.

The server 104 can also use the information in the crop harvest knowledge corpus 122 to determine a harvest amount at each of the field locations. (e.g., number of X per trees * number of trees of X per field). In addition, in some embodiments, the server 104 can predict the harvesting date and the harvesting amount based on the intended use of the crop and/or based on the expected transport or storage of the crop after harvesting. For example, for certain uses of a crop, the crop may be harvested at different stages of growth (not ripe, ripe, or over ripe). Additionally, when the crop is sold for immediate fresh market consumption (e.g., going straight to a nearby farmers market), the seller may want crops that are perfectly ripe and harvested off the tree just prior to being sold, whereas when the crop has to be transported and stored for several days or weeks, the predicted harvest date/amount may be different.

In an embodiment, the transport database 124 includes transportation scheduling and route information for all field locations being managed by the server 104. The server 104 uses information from the transport database 124 to determine the transport time, route, and destination location for a crop. In an embodiment, the server 104 can also be configured to optimize the scheduling and transportation of crops from one or more field locations to reduce food waste, increase freshness/quality, and reduce transport cost. For example, in an embodiment, based on a predicted date and amount of a crop and the transport and/or destination location for the crop, the server 104 determines whether the transport of the harvested crop can be combined with the transport of a second harvested crop (may or may not be the same type of crop) from the same field location or a second field location (e.g., a field located along a transport route). In some embodiments, the server 104 may determine that a crop harvest can be delayed or expedited (e.g., wait a few days after or harvest a few days earlier than a predicted harvest ready date) without affecting the quality of the crop so that the transport of crop can be combined with the transport of another crop (at the same or different location).

The server 104 can further monitor in real-time the transport of one or more crops by communicating with the transport vehicle 120. The transport vehicle 120 may be manually driven or may include autonomous driving capabilities. In an embodiment, the server 104 can monitor the location, route, storage temperature (e.g., refrigerated truck) or vehicle temperature, weight, available space, fuel/charge, vehicle maintenance, alerts, or other parameters for optimizing the transport of the one or more crops.

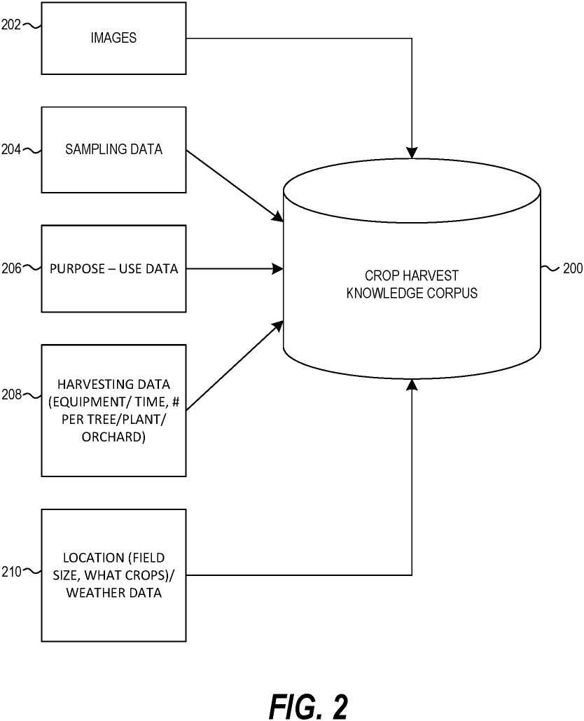

FIG. 2 is a diagram illustrating a crop harvest knowledge corpus 200 in accordance with an embodiment of the present disclosure. The crop harvest knowledge corpus 200 is an example of the crop harvest knowledge corpus 122 that can be used by the server 104 to predict a harvest date and harvest amount in FIG. 1. In the depicted embodiment, the crop harvest knowledge corpus 200 includes images 202. The images 202 are images of various crop at different stages of growth (e.g., germination-sprouting-flowering-ripening stages). The images may be obtained by taking live pictures or videos of a crop during its growth cycle. The images may also be obtained from one or more online source. The images 202 includes data indicating the date/time when the image was captured. The images and data can then be used, along with other information, to predict a harvest date of a crop (e.g., by comparing images of past crop growth cycle to a current image of a crop during its growth cycle).

The crop harvest knowledge corpus 200 also includes sampling data 204 of various crop at different stages of growth. The sampling data 204 includes characteristics of a crop during its growth cycle. For example, the sampling data 204 may include information such as size, color, firmness, acidity, sugar and/or starch content, or other data that can used to predict a harvest date/amount of a crop. As a non-limiting example, as apples ripen, there will be a series of physicochemical changes taking place in the fruit. Some of these changes include: increase in size, decrease in chlorophyll levels, increase in skin coloration, seeds turn into a darker color, fruit respiration and ethylene production increases, flesh begins to soften, the starch in the flesh is converted to sugars, and acidity levels decrease. Additionally, data may be stored for the various types of apples (e.g., Gala, McIntosh, Fuji, Golden, etc.). For instance, the coloration of an apple will differ depending on the cultivar/ strain (solid red, striped red, green, or yellow). The data can include the optimal harvest values of the various characteristics of each crop. For example, the optimum time to harvest a particular type of apple at a particular location may be when the sugar content is around 12% to 14% Soluble Solids Contents (SSC), the firmness is around 15 lbs., the starch-iodine index is 5.0, etc. The data for the optimum time to harvest the same type of apple may differ depending on location.

In certain embodiments, the crop harvest knowledge corpus 200 may also include purpose-use data 206 of various crops that may have an effect on their harvest date/amount. For instance, for certain uses of a crop, the crop may be harvested at different stages of growth as compared to when the crop is harvested for immediate consumption. For example, a crop that is used as an ingredient in another food product such as for animal feed or other products may be harvested earlier or later than when the crop is consumed fresh from the field. As another example, green mangos can be harvested for manufacturing pickles, while ripe mangos can be harvested for immediate consumption.

The crop harvest knowledge corpus 200 may also include harvesting data 208 that contains various data related to the harvesting of a crop. For example, the harvesting data 208 may include harvesting method (hand or by machinery), required equipment (a Combine, Harvesting Rig, Mower, etc.) or tools, man-hours per plant/tree/field size, number of crops per plant/tree, and storage requirements.

The crop harvest knowledge corpus 200 may also include location data 210 that contains various data related to each field location. For example, the location data 210 may include the address or Global Positioning System (GPS) coordinates of a field, the size of the field, crop grown at the field, number of trees/plants at the field, date planted, weather data for the location, or other information pertaining to a particular field.

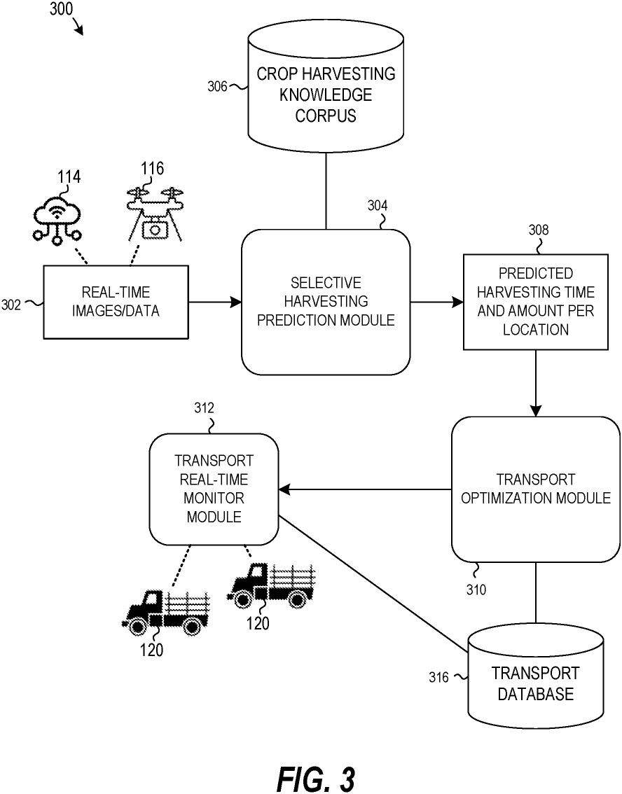

FIG. 3 is a diagram illustrating a crop harvest prediction and transport process 300 in accordance with an embodiment of the present disclosure. The crop harvest prediction and transport process 300 may be performed by a harvesting supply chain logistics system, or other computing systems, such as, but not limited to the server 104 in FIG. 1. In the depicted embodiment, a selective harvesting prediction module 304 receives as input real-time images and data 302 of a crop located at a field location. The real-time images are images or videos taken recently of the crop during its growth cycle. The data can include metadata indicating when (e.g., time and date) and where (i.e., location information) the image was taken. The data may also include, but not limited to, weather data, soil data, crop sampling data, purpose or intended-use data, and field size (e.g., number of trees/plants) data.

The selective harvesting prediction module 304 analyzes the real-time images and data 302 using the information contained in a crop harvesting knowledge corpus 306. Example implementations of the crop harvesting knowledge corpus 306 is the crop harvest knowledge corpus 200 in FIG. 2 and the crop harvest knowledge corpus 122 in FIG. 1. In an embodiment, the selective harvesting prediction module 304 compares the real-time images to the images stored in the crop harvesting knowledge corpus 306 to identify the crop (if type of crop is unknown). In an embodiment, a machine learning model is trained using the images in the crop harvesting knowledge corpus 306 to identify the type of crop in the real-time images/data 302. The selective harvesting prediction module 304 compares the data from the real-time images/data 302 (e.g., crop, color, sampling data, intended-use, etc.) to the data stored in the crop harvesting knowledge corpus 306 for the identified crop to determine a growth stage of the crop (if unknown) and to predict a harvest date or range (e.g., harvest in 30-35 days or between July 1-July 7) of the crop. The selective harvesting prediction module 304 also predicts a harvest amount of the crop on the predicted harvest date. For example, the harvested amount may be the number of predicted crops per tree times the number of trees at a location. In some cases, the number of predicted crops per tree may be just a portion of the crops of a tree/plant such as when the crops closer to the exterior of the tree ripens faster than the crops further in the tree. In these cases, the selective harvesting prediction module 304 may provide more than one predicted harvest date/range and amount for a crop at a location.

The selective harvesting prediction module 304 passes the predicted harvest data and amount of the crop at the location to a transport optimization module 310. The transport optimization module 310 is configured to optimize the transport of the crop from the location to its intended destination (e.g., distributor, retailer, etc.). The transport optimization module 310 may communicate with a transport database 316. In an embodiment, the transport database 316 stores the transport schedules (i.e., previously scheduled transports). The transport database 316 may also store the transport requirements of a crop, cost, and other data related to the transport of a crop. For example, the transport database 316 may store information on the location, number, and types of transport vehicles that are available for use. The transport database 316 may also contain the schedules, hours, and locations of drivers available to be scheduled for the transport.

In an embodiment, the transport optimization module 310 determines the type and number of vehicles required for transporting the predicted harvested amount using the transport database 316. In an embodiment, the transport optimization module 310 considers various factors including, but not limited to, time, cost, route, crop quality, and the predicted harvest date/amount of the same crop or other crops at either the same location or another location in optimizing the transport of the crop. For example, in an embodiment, if a first crop at a first location has a predicted harvest range of June 1- June 3, and a second crop at a second location has a predicted harvest range of June 3 - June 7, the transport optimization module 310 may determine that it would be optimal to harvest both the first crop and the second crop on June 3^{rd}, or harvest the firstcrop on June 3^{rd} and the second crop on June 4^{th} (depending on how long it takes to harvest and the distance between the first location and the second location), and combine the transport of the first crop with the transport of the second crop.

In some embodiments, the transport optimization module 310 may determine that the optimum transport of a crop occurs outside of the predicted harvest range of the crop. For instance, in the above example, the transport optimization module 310 may determine that it would be optimum to harvest or transport the first crop at the first location on June 4^{th} (outside the predicted harvest range) so that transport of the crop can be combined with the transport of the second crop on June 4^{th} at the second location. In some cases, the transport optimization module 310 may alter an existing/previously scheduled transport of another crop to combine transport with the new predicted crop harvest. Once the transport optimization module 310 determines the optimum transport for the predicted crop harvest, the transport optimization module 310 schedules the transport for the predicted crop harvest. The transport optimization module 310 updates the transport database 316 with the new transport schedule for the predicted crop harvest.

In an embodiment, once the crop is harvested and loaded on to the transport vehicle, a transport real-time monitor module 312 can monitor the location of the transport vehicle in real-time to ensure that the transportation of the crop is proceeding according to schedule. The transport real-time monitor module 312 updates the transport database 316 once the transport of the crop is complete.

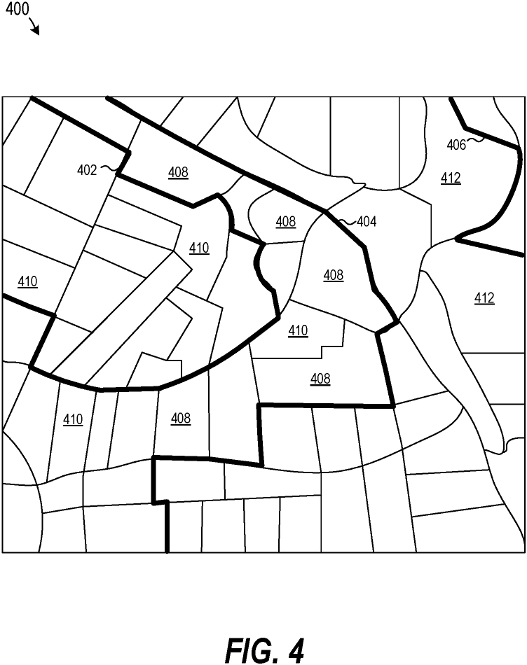

FIG. 4 is diagram illustrating a map 400 of in accordance with an embodiment of the present disclosure. In the depicted embodiment, the map 400 depicts a large rural area (e.g., a large county or multiple counties) that includes a plurality of crop fields as indicated by the block regions. Each of the crop fields grows one or more crops. In an embodiment, the map 400 is utilized by the transport optimization module 310 in FIG. 3 to determine the optimal schedule and route for transporting crops from the plurality of crop fields based on their predicted harvest date and amount. As a non-limiting example, in the depicted embodiment, the transport optimization module 310 determines that the optimal transport for the predicted harvested date/amount of crops for the crop fields 408 are to be combined and transported along Route 404. Similarly, the transport optimization module 310 determines that the optimal transport for the predicted harvested date/amount of crops for the crop fields 410 are to be combined and transported along Route 402, and the optimal transport for the predicted harvested date/amount of crops for the crop fields 412 are to be combined and transported along Route 406.

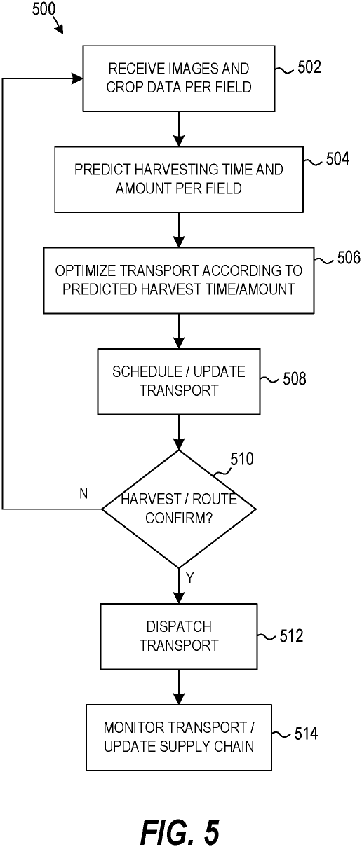

FIG. 5 is a flowchart illustrating a process 500 for predicting a crop harvesting date and transport scheduling in accordance with an embodiment of the present disclosure. The process 500 may be performed by a harvesting supply chain logistics system, or other computing systems, such as, but not limited to the server 104 in FIG. 1. The process 500 begins at step 502 with the harvesting supply chain logistics system receiving images and crop data for a plurality of crop fields. At step 504, the harvesting supply chain logistics system analyzes the images and crop data to predict a harvest date or window, and a harvest amount. Based on the predicted harvest date and amount, the harvesting supply chain logistics system, at step 506, determines the optimal transport schedule for transporting the predicted harvest amount. At step 508, the harvesting supply chain logistics system schedules or updates the transport for the predicted harvest amount according to the optimum schedule.

At step 510, the harvesting supply chain logistics system determines whether the predicted harvest amount and transport route is confirmed (i.e., crop harvesting is proceeding according to schedule). When the transport for the predicted harvest amount and route has not been confirmed (e.g., when the predicted harvested date has not occurred), the harvesting supply chain logistics system continually monitors and updates the predicted harvest date/amount and transport schedule by repeating steps 502 - 508. For example, the harvesting supply chain logistics system can receive updated images/data daily, weekly, or periodically, and perform and update the predicted harvest date/amount and the corresponding transport schedule as needed. For instance, if weather conditions changed drastically after the last prediction, the predicted harvest data and amount may also change. In this case, the optimal transport schedule could also be updated based on the change.

Once the predicted harvest amount and transport route is confirmed, the harvesting supply chain logistics system, at step 512, dispatches the schedule transport vehicle(s) according to the optimal route for transporting the predicted harvest amount. At step 514, the harvesting supply chain logistics system monitors in real-time the progress of the transport and updates the supply chain information (e.g., notifies vendors, warehouse, retailers, etc.)

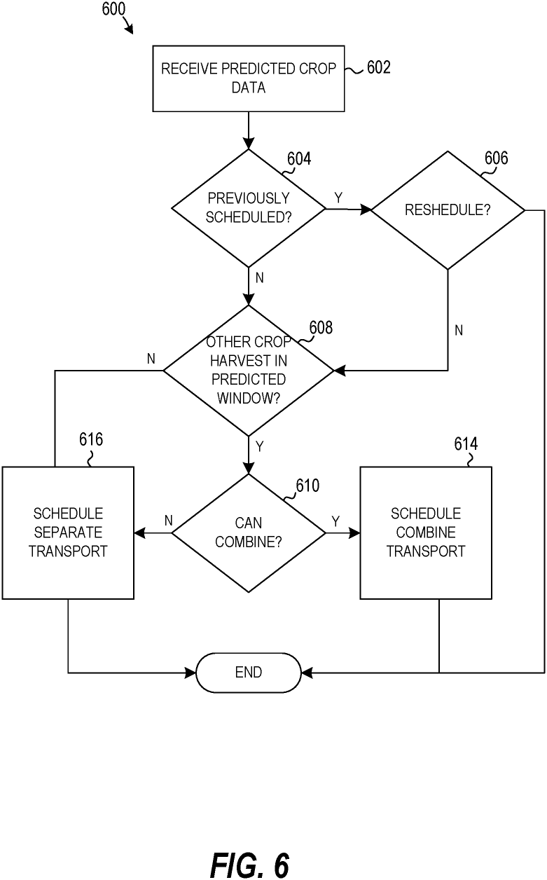

FIG. 6 is a flowchart illustrating a process 600 for optimizing transport of a crop in accordance with an embodiment of the present disclosure. The process 600 may be performed by a harvesting supply chain logistics system, or other computing systems, such as, but not limited to the server 104 in FIG. 1. The process 600 begins at step 602 with the harvesting supply chain logistics system receiving predicted crop harvesting data. The predicted crop harvesting data may include information on a first crop such as the type of crop, location, the predicted date/range, predicted harvested amount, and any special requirements for the transport of the crop. At step 604, the harvesting supply chain logistics system determines whether transport for the predicted harvest of the first crop has been previously scheduled. When the transport for the predicted harvest of the first crop has been previously scheduled, the harvesting supply chain logistics system determines, at step 606, whether the transport for the predicted harvest of the first crop needs to be rescheduled based on the updated predicted crop data information. When the transport for the predicted harvest of the first crop does not need to be rescheduled, the harvesting supply chain logistics system terminates the process 600.

However, when, at step 604, the transport for the predicted harvest of the first crop has not been scheduled or when, at step 606, the transport for the predicted harvest of the first crop requires to be rescheduled, the harvesting supply chain logistics system determines, at step 608, whether there are other crops (e.g., a second crop) scheduled to be harvest within the same window as the predicted date/range of the first crop (e.g., within 3 days of the predicted date/range). When there are other crops scheduled to be harvested within the same window as the predicted date/range of the crop, the harvesting supply chain logistics system determines, at step 610, whether the transport for the other crops can be combined with the transport of the first crop. For example, in an embodiment, the transport for a second crop can be combined with the transport of the first crop when there is enough available space for the predicted harvest amount, the location of the first crop is along or close (e.g., within a certain range) to a transport route of the second crop, and combining the transport of the first and the second crop do not affect the quality of either the first or second crop (e.g., if combining the transport of the first crop would cause a delay and affect the quality of the second crop, the transport should not be combined). When the transport of a second crop can be combined with the transport of the first crop, the harvesting supply chain logistics system, at step 614, schedules the combine transport of the crops. When, at step 608, there is not a second crop scheduled to be harvest within the same window as predicted date/range of the crop, or when, at step 610, the transport of a second crop cannot be combined with the transport of the first crop, the harvesting supply chain logistics system, at step 616, schedules separate transport for the first crop.

The harvesting supply chain logistics system can continue to receive additional predicted crop harvesting data for a third crop, fourth crop, fifth crop, etc. (not shown in flowchart). The harvesting supply chain logistics system can repeat the process 600 to determine whether the new crop data affects the transport of one or more crops from one or more locations. For example, if the harvesting supply chain logistics system receives predicted crop harvesting data for a third crop from a third location, and determines that the transport for the third crop can be combined with the transport of the first and second crops, then the harvesting supply chain logistics system can update the transport schedule accordingly. In some embodiments, the harvesting supply chain logistics system may determine that it would better to combine the transport of the third crop with just the first or second crop, and reschedule/rearrange the transport of the previously scheduled transport. For example, instead of combining the transport of the first and second crop as previously scheduled, the harvesting supply chain logistics system may determine that it is best to transport the first crop by itself and combine the transport of the second crop with the transport of the third crop. Thus, the harvesting supply chain logistics system can dynamically and continually update the transport schedule to optimize transport of crops from multiple growers at different locations to improve supply chain logistics, food quality, transport time, and cost.

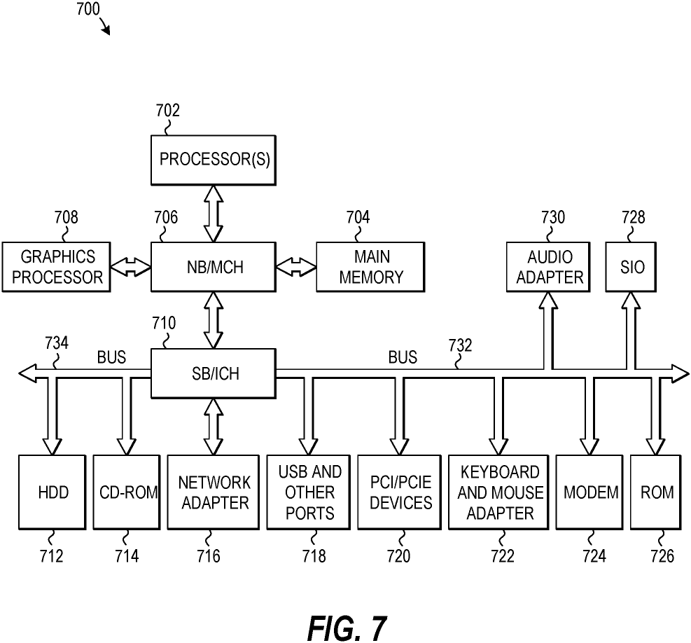

FIG. 7 is a block diagram illustrating a hardware architecture of a system 700 according to an embodiment of the present disclosure in which aspects of the illustrative embodiments may be implemented. For example, in an embodiment, a harvesting supply chain logistics system may be implemented using the data processing system 700. In the depicted example, the data processing system 700 employs a hub architecture including north bridge and memory controller hub (NB/MCH) 706 and south bridge and input/output (I/O) controller hub (SB/ICH) 710. Processor(s) 702, main memory 704, and graphics processor 708 are connected to NB/MCH 706. Graphics processor 708 may be connected to NB/MCH 706 through an accelerated graphics port (AGP). A computer bus, such as bus 732 or bus 734, may be implemented using any type of communication fabric or architecture that provides for a transfer of data between different components or devices attached to the fabric or architecture.

In the depicted example, network adapter 716 connects to SB/ICH 710. Audio adapter 730, keyboard and mouse adapter 722, modem 724, read-only memory (ROM) 726, hard disk drive (HDD) 712, compact disk read-only memory (CD-ROM) drive 714, universal serial bus (USB) ports and other communication ports 718, and peripheral component interconnect/peripheral component interconnect express (PCI/PCIe) devices 720 connect to SB/ICH 710 through bus 732 and bus 734. PCI/PCIe devices may include, for example, Ethernet adapters, add-in cards, and personal computing (PC) cards for notebook computers. PCI uses a card bus controller, while PCIe does not. ROM 726 may be, for example, a flash basic input/output system (BIOS). Modem 724 or network adapter 716 may be used to transmit and receive data over a network such as the communication network 102 in FIG. 1.

HDD 712 and CD-ROM drive 714 connect to SB/ICH 710 through bus 734. HDD 712 and CD-ROM drive 714 may use, for example, an integrated drive electronics (IDE) or serial advanced technology attachment (SATA) interface. In some embodiments, HDD 712 may be replaced by other forms of data storage devices including, but not limited to, solid-state drives (SSDs). A super I/O (SIO) device 728 may be connected to SB/ICH 710. SIO device 728 may be a chip on the motherboard configured to assist in performing less demanding controller functions for the SB/ICH 710 such as controlling a printer port, controlling a fan, and/or controlling the small light emitting diodes (LEDS) of the data processing system 700.

The data processing system 700 may include a single processor 702 or may include a plurality of processors 702. Additionally, processor(s) 702 may have multiple cores. For example, in one embodiment, data processing system 700 may employ a large number of processors 702 that include hundreds or thousands of processor cores. In some embodiments, the processors 702 may be configured to perform a set of coordinated computations in parallel.

An operating system is executed on the data processing system 700 using the processor(s) 702. The operating system coordinates and provides control of various components within the data processing system 700 in FIG. 7. Various applications and services may run in conjunction with the operating system. Instructions for the operating system, applications, and other data are located on storage devices, such as one or more HDD 712, and may be loaded into main memory 704 for execution by processor(s) 702. In some embodiments, additional instructions or data may be stored on one or more external devices. The processes described herein for the illustrative embodiments may be performed by processor(s) 702 using computer usable program code, which may be located in a memory such as, for example, main memory 704, ROM 726, or in one or more peripheral devices.

The disclosed embodiments may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random-access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the disclosed embodiments are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented method, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. Further, the steps of the methods described herein may be carried out in any suitable order, or simultaneously where appropriate. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for coordinating harvesting and transport of crops, the method comprising:
receiving first crop data of a first crop grown at a first location by a first food producer;
predicting a first harvesting time and a first harvesting amount of the first crop;
receiving second crop data of a second crop grown at a second location by a second food producer;
predicting a second harvesting time and a second harvesting amount of the second crop;
determining whether a transport for the first crop and the second crop can be combined based on the first harvesting time, first harvesting amount, the second harvesting time, and the second harvesting amount; and
scheduling a first combine transport of the first crop and the second crop when the first crop and the second crop can be combined.

2. The computer-implemented method of claim 1, wherein the first crop is a different type of crop than the second crop.

3. The computer-implemented method of claim 1, wherein the first crop data comprises an image of the first crop.

4. The computer-implemented method of claim 3, further comprising analyzing the image of the first crop to determine a growth state of the first crop in predicting the first harvesting time and the first harvesting amount of the first crop.

5. The computer-implemented method of claim 1, wherein the first crop data comprises a harvest use of the first crop, and wherein predicting the first harvesting time and the first harvesting amount of the first crop is based on the harvest use of the first crop.

6. The computer-implemented method of claim 1, wherein determining whether the transport for the first crop and the second crop can be combined comprises determining whether the second location is within a range of a transport route of the first crop.

7. The computer-implemented method of claim 1, further comprising:
receiving third crop data of a third crop grown at a third location by a third food producer;
predicting a third harvesting time and a third harvesting amount of the third crop;
determining whether a transport for the third crop can be combined with a transport of at least one of the first crop and the second crop; and
scheduling a second combine transport of the third crop with at least one of the first crop and the second crop when the third crop can be combined with a transport of at least one of the first crop and the second crop, wherein scheduling the second combine transport comprises altering the first combine transport.

8. A system configured to coordinate harvesting and transport of crops from multiple food producers, the system comprising memory for storing instructions, and a processor configured to execute the instructions to:
receive first crop data of a first crop grown at a first location by a first food producer;
predict a first harvesting time and a first harvesting amount of the first crop;
receive second crop data of a second crop grown at a second location by a second food producer;
predict a second harvesting time and a second harvesting amount of the second crop;
determine whether a transport for the first crop and the second crop can be combined based on the first harvesting time, first harvesting amount, the second harvesting time, and the second harvesting amount; and
schedule a first combine transport of the first crop and the second crop when the first crop and the second crop can be combined.

9. The system of claim 8, wherein the first crop is a different type of crop than the second crop.

10. The system of claim 8, wherein the first crop data comprises an image of the first crop.

11. The system of claim 10, wherein the processor is configured to execute the instructions to analyze the image of the first crop to determine a growth state of the first crop in predicting the first harvesting time and the first harvesting amount of the first crop.

12. The system of claim 8, wherein the first crop data comprises a harvest use of the first crop, and wherein predicting the first harvesting time and the first harvesting amount of the first crop is based on the harvest use of the first crop.

13. The system of claim 8, wherein determining whether the transport for the first crop and the second crop can be combined comprises determining whether the second location is within a range of a transport route of the first crop.

14. The system of claim 8, wherein the processor is configured to execute the instructions to:
receive third crop data of a third crop grown at a third location by a third food producer;
predict a third harvesting time and a third harvesting amount of the third crop;
determine whether a transport for the third crop can be combined with a transport of at least one of the first crop and the second crop; and
schedule a second combine transport of the third crop with at least one of the first crop and the second crop when the third crop can be combined with a transport of at least one of the first crop and the second crop, wherein scheduling the second combine transport comprises altering the first combine transport.

15. A computer program product for coordinating harvest and transport of crops from multiple food producers, the computer program product comprising a computer readable storage medium having program instructions embodied therewith, the program instructions executable by a processor of a system to cause system to:
receive first crop data of a first crop grown at a first location by a first food producer;
predict a first harvesting time and a first harvesting amount of the first crop;
receive second crop data of a second crop grown at a second location by a second food producer;
predict a second harvesting time and a second harvesting amount of the second crop;
determine whether a transport for the first crop and the second crop can be combined based on the first harvesting time, first harvesting amount, the second harvesting time, and the second harvesting amount; and
schedule a first combine transport of the first crop and the second crop when the first crop and the second crop can be combined.

16. The computer program product of claim 15, wherein the first crop is a different type of crop than the second crop.

17. The computer program product of claim 15, wherein the program instructions executable by the processor of the system further causes the system to analyze an image of the first crop to determine a growth state of the first crop in predicting the first harvesting time and the first harvesting amount of the first crop.

18. The computer program product of claim 15, wherein the first crop data comprises a harvest use of the first crop, and wherein predicting the first harvesting time and the first harvesting amount of the first crop is based on the harvest use of the first crop.

19. The computer program product of claim 15, wherein determining whether the transport for the first crop and the second crop can be combined comprises determining whether the second location is within a range of a transport route of the first crop.

20. The computer program product of claim 15, wherein the program instructions executable by the processor of the system further causes the system to:
receive third crop data of a third crop grown at a third location by a third food producer;
predict a third harvesting time and a third harvesting amount of the third crop;
determine whether a transport for the third crop can be combined with a transport of at least one of the first crop and the second crop; and
schedule a second combine transport of the third crop with at least one of the first crop and the second crop when the third crop can be combined with a transport of at least one of the first crop and the second crop, wherein scheduling the second combine transport comprises altering the first combine transport.
